(19) United States
(12) Patent Application Publication
(10) Pub. No.: US 2016/0173541 A1
(43) Pub. Date: Jun. 16, 2016

(54) PRESENTATION OF CONTENT FROM WITHIN SPREADSHEET APPLICATION

(71) Applicant: Microsoft Technology Licensing, LLC, Redmond, WA (US)

(72) Inventor: Amit Gusain, Bothell, WA (US)

(21) Appl. No.: 14/569,600

(22) Filed: Dec. 12, 2014

(51) Int. Cl. H04L 29/06; H04L 29/08; G06F 17/24

(52) U.S. Cl. CPC H04L 65/403; G06F 17/246; H04L 67/02; G06F 17/24

(57) ABSTRACT

A spreadsheet application may enable a user to organize, analyze, and store data in a tabular form. In some situations, the user may want to provide a brief presentation of the data to one or more recipients. A presentation module of the spreadsheet application may be configured to enable the user to dynamically present the data from within the spreadsheet application to the recipients. For example, a selected portion of underlying data of the spreadsheet application may be received, and a presentation to display the selected portion of the underlying data may be generated. The presentation may be displayed to the recipients through a presentation viewer, and the recipients may be enabled to modify the presentation through the presentation viewer. In response to detecting a modification to the presentation through the presentation viewer, the corresponding underlying data of the spreadsheet application may be automatically updated to reflect the modification.

### BACKGROUND

A spreadsheet application may enable a user to organize, analyze, and store data in a tabular form. In some situations, the user may want to provide a brief presentation or summary of the data from his/her spreadsheet to one or more recipients. To provide such a presentation and/or summary using current implementations, the user has to copy the data from the spreadsheet application, and paste the copied data into a presentation application for presentation to the recipients. Additionally, if the user needs to modify the presented data, the user must modify the data within the spreadsheet application and then copy the modified data back into the presentation application.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter. Embodiments are directed to presentation of content from within a spreadsheet application that includes receiving one or more selected portions of underlying data of the spreadsheet application, generating a presentation to display the selected portions of underlying data, and enabling display of the presentation to one or more recipients through a presentation viewer, wherein the one or more recipients are enabled to modify the displayed presentation through the presentation viewer.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes an example network environment where a spreadsheet application may be hosted by a data center;

FIG. 2 illustrates an example network environment where a spreadsheet application enabled to present content from within may be locally installed on a client device;

FIG. 3 illustrates another example network environment where a spreadsheet application enabled to present content from within may be locally installed on a mobile device;

FIG. 4 illustrates an example conceptual diagram where content may be presented from within a spreadsheet application in a collaborative environment;

FIGS. 5A-5C illustrate an example user experience provided to enable a user to select content for presentation from within a spreadsheet application;

FIGS. 6A-6C illustrate an example user experience provided to enable a user to dynamically present content from within a spreadsheet application to recipients, where the recipients are enabled to modify the presented content;

FIG. 7 is a block diagram of an example general purpose computing device, which may be used to present content from within a spreadsheet application; and

FIG. 8 illustrates a logic flow diagram of a method to present content from within a spreadsheet application, according to embodiments.

### DETAILED DESCRIPTION

As briefly described above, a spreadsheet application may enable a user to organize, analyze, and store data in a tabular form. Additionally, a presentation module of the spreadsheet application may be configured to enable the user to dynamically present the data from within the spreadsheet application to one or more recipients. For example, the presentation module may be configured to receive a selected portion of underlying data of the spreadsheet application, and generate a presentation to display the selected portion of the underlying data. The display of the presentation to the recipients may be enabled through a presentation viewer, where the recipients may be enabled to modify the presentation through the presentation viewer. For example, the recipients may be enabled to add, delete, edit, and/or comment on the presentation through the presentation viewer. In response to detecting a modification to the presentation through the presentation viewer, the corresponding underlying data of the spreadsheet application may be automatically updated to reflect the modification.

In the following detailed description, references are made to the accompanying drawings that form a part hereof, and in which are shown by way of illustrations, specific embodiments, or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While some embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Some embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for employment of context-based inference to automatically save content to a location within one or more containers of a repository. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

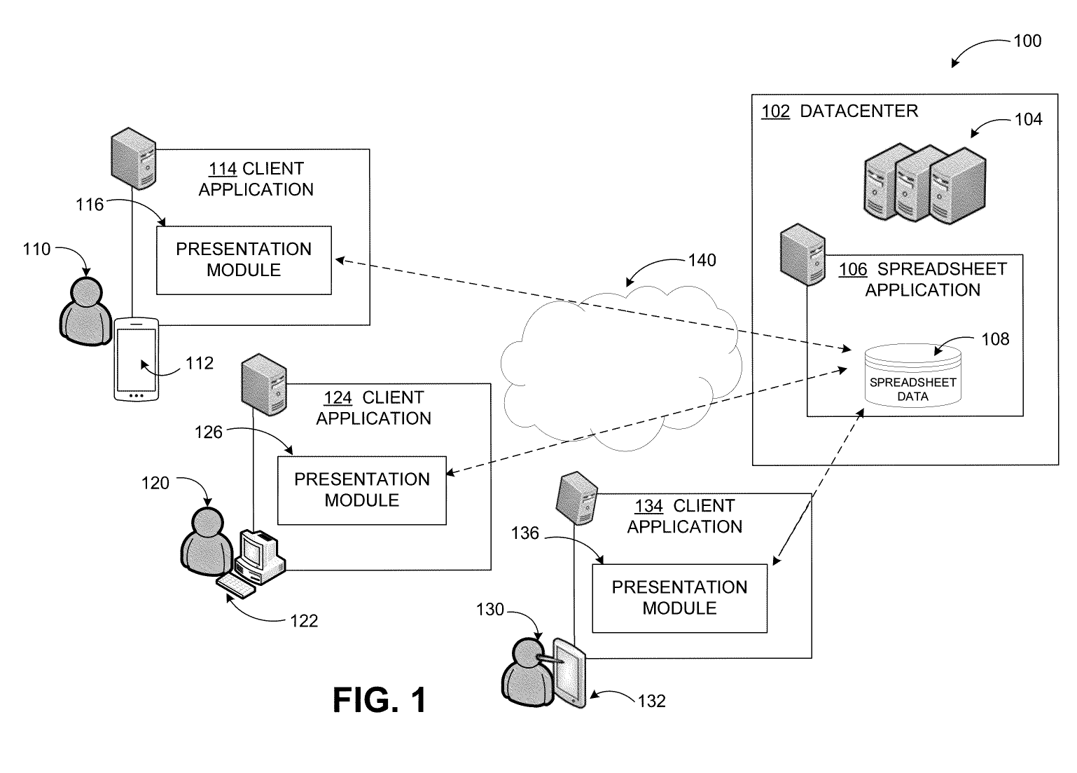

FIG. 1 includes an example network environment where a spreadsheet application may be hosted by a data center. As shown in diagram 100, a datacenter 102 may include a plurality of servers 104 configured to, among other things, host a productivity service. The productivity service may provide one or more users 110, 120, 130 access to one or more applications, such as a spreadsheet application 106 that upon execution may enable the users 110, 120, 130 to organize, analyze, and store data in a tabular form. The datacenter 102 may further upload and/or store data associated with the applications, such as underlying data 108 from the spreadsheet application 106, for example. Access to the spreadsheet application 106 may be provided through one or more client applications 114, 124, 134 executed on client devices 112, 122, 132 associated with the users 110, 120, 130. Example client devices may include a desktop computer, a laptop, a tablet, a smart phone, and a wearable, among other similar computing devices. In some examples, the client applications 114, 124, 134 may include presentation modules 116, 126, 136.

In an example embodiment, the presentation modules 116, 126, 136 may be configured to receive a selected portion of the underlying data 108 from the spreadsheet application 106 over a network such as a cloud 140. In some examples, each of the presentation modules 116, 126, 136 may receive a different selected portion of the underlying data 108 relevant to the associated users 110, 120, 130. The selected portion of the underlying data 108 may include cells, columns, rows, tables, charts, graphs, images, and any other spreadsheet objects, for example.

The presentation modules 116, 126, 136 may then be configured to generate a presentation to display the selected portion of underlying data 108, and enable display of the presentation to one or more recipients through a presentation viewer. In some embodiments, the generated presentation may include one or more slides, similar to a conventional presentation document. The recipients may include a user that selected the selected portion of underlying data 108 and one or more other users intended to receive the presentation through the presentation viewer. For example, the other users may include one or more co-authors in a collaborative environment. The presentation viewer may employ a textual scheme, a graphical scheme, an audio scheme, an animation scheme, a coloring scheme, a highlighting scheme, and/or a shading scheme to enhance the display of the presentation.

In some examples, the recipients may be enabled to modify the displayed presentation through the presentation viewer. In response to detecting a modification to the presentation through the presentation viewer, the presentation modules 116, 126, and 136 may be configured to automatically update corresponding underlying data 108 from the spreadsheet application 106 to reflect the modification. The modification may include an addition, a deletion, an edit, a comment, formatting, and/or inking associated with one or more elements of the presentation, among other examples. Furthermore, the presentation modules 116, 126, and 136 may be configured to provide a summary of the modification through the spreadsheet application 106 and/or the presentation viewer. In some embodiments, permissions associated with the modifications may be assigned to each user. For example, a recipient who is a co-author of the presentation may be assigned permissions that enable the recipient to add, delete, edit, and comment on elements of the presentation. Another recipient may only be assigned permissions that enable the other recipient to comment on the elements of the presentation.

In other examples, the recipients may be enabled to modify the selected portion of the underlying data through the spreadsheet application. In response to detecting a modification to the selected portion of the underlying data through the spreadsheet application, corresponding presentation elements displayed through the presentation viewer may be automatically updated to reflect the modification. A summary of the modification may be provided to the recipients through the spreadsheet application 106 and/or the presentation viewer.

As previously discussed, to present content from a spreadsheet application using current implementations, the user has to copy data from the spreadsheet application, and paste the copied data into a presentation application for presentation to the recipients. Additionally, if the user needs to modify the presented data, the user must modify the data within the spreadsheet application and then copy the modified data back into the presentation application, which may be time consuming and non-conducive to collaborative environments.

Presentation of content from within a spreadsheet application, as described in the embodiments herein, may enable a single application with spreadsheet and presentation capabilities to be executed in order to present and dynamically modify the content, increasing user and recipient performance and efficiency. For example, the dynamic updates of modified data between the spreadsheet application and the presentation viewer may save the user time and frustration by not having to copy and paste data continuously between applications, especially in collaborative environments. Additionally, by enabling the user to select only relevant portions for presentation, the presentation may be friendly to view on devices with smaller display screens, such as mobile devices.

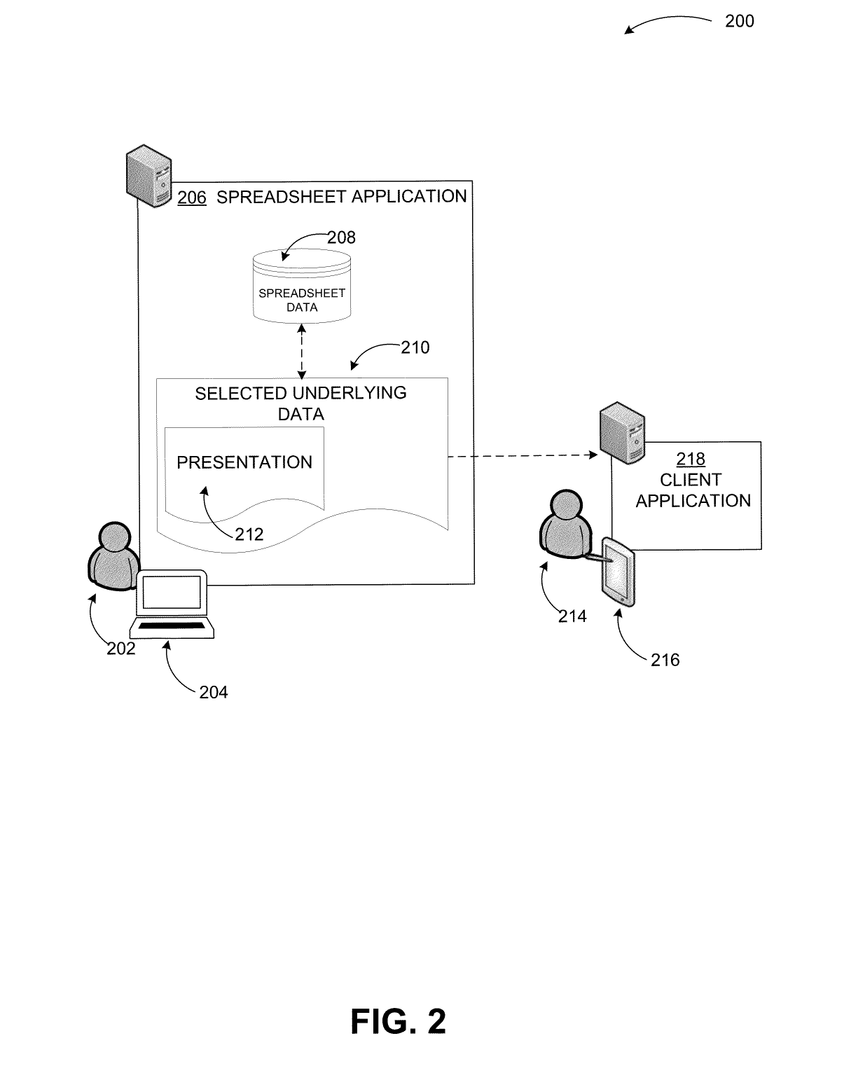

FIG. 2 illustrates an example network environment where a spreadsheet application enabled to present content from within may be locally installed on a client device. As shown in a diagram 200, a spreadsheet application 206 may be executed locally on a client device 204, such as a laptop, associated with a user 202. The spreadsheet application 206 may include a data store 208 comprising underlying data associated with the spreadsheet application 206. The user 202 may be enabled to select a portion of the underlying data 210 to present to one or more recipients, such as the user 202 and the recipient 214. For example, the user 202 may be enabled to select the portion of the underlying data 210 for presentation through a control element displayed on a user experience associated with the spreadsheet application 206. In another example, the user experience associated with the spreadsheet application 206 may automatically provide the user 202 an option to present the portion of the underlying data 210 in response to selection of the portion of the underlying data 210. Alternatively, other controls associated with inputs of the client device 204, such as such as keyboard shortcuts, may be used to select the portion of the underlying data 210 for presentation.

A presentation 212 to display the selected portion of underlying data 210 may be generated, and the presentation 212 may be presented to the user 202 through a presentation viewer displayed on the client device 204. As illustrated, the selected portion of the underlying data 210 and the presentation 212 may be transmitted as a single file to a client application 218 executed on a client device 216, such as a tablet, associated with the recipient 214 for presentation to the recipient 214. Similarly, the presentation 212 may be presented to the recipient 214 through a presentation viewer displayed on the client device 216.

Both the user 202 and the recipient 214 may be enabled to modify the presentation 212 through the presentation viewer, where modifications may include an addition, a deletion, an edit, a comment, and other similar modifications to one or more elements of the presentation 212. In some examples, permissions associated with the modifications may be assigned to the user 202 and the recipient 214. For example, the user 202 may be a creator of the selected portion of the underlying data 210 and therefore, have full permissions to modify the presentation 212. The recipient 214 may be a reviewer, and therefore have limited permissions to edit and/or comment on the presentation 212.

In response to detecting a modification to the presentation 212 through the presentation viewer by the user 202 and/or the recipient 214, the corresponding underlying data 210 from the spreadsheet application 206 may be automatically updated to reflect the modification. Furthermore, a summary of the modification may be provided to the user 202 and the recipient 214 through the respective presentation viewers.

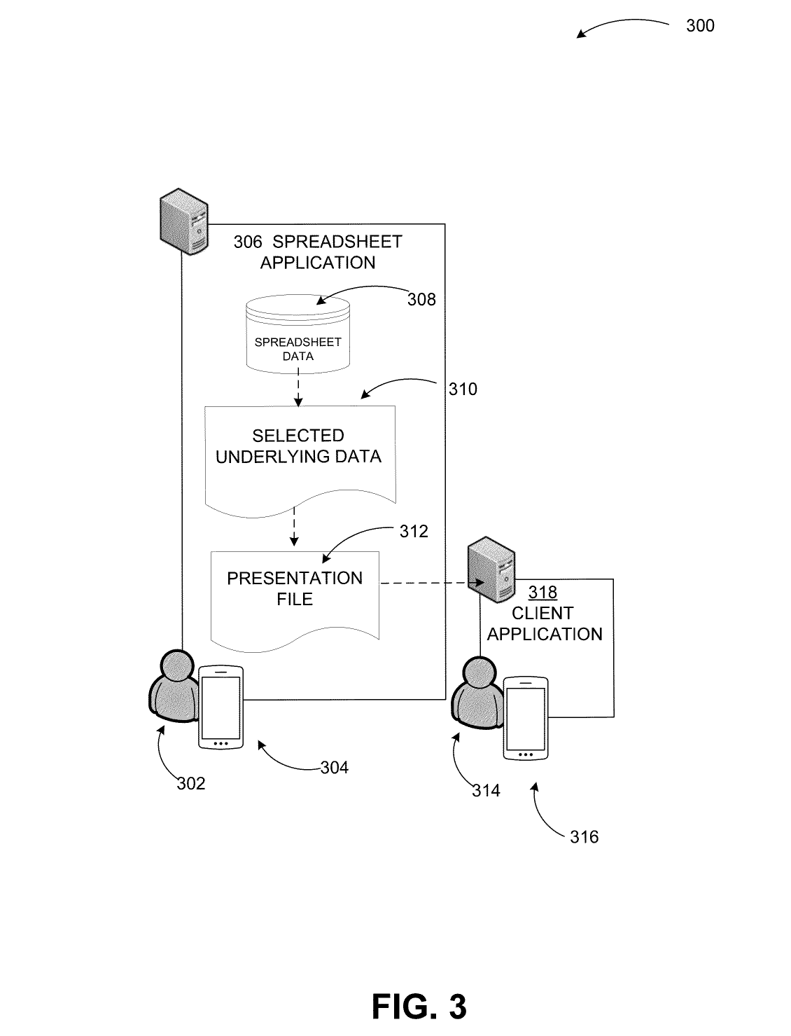

FIG. 3 illustrates another example network environment where a spreadsheet application enabled to present content from within may be locally installed on a mobile device. As shown in a diagram 300, a spreadsheet application 306 may be executed locally on a mobile device 304, such as a smart phone, associated with a user 302. The spreadsheet application 306 may include a data store 308 comprising underlying data associated with the spreadsheet application 306. The user 302 may be enabled to select a portion of the underlying data 310 to present to one or more recipients, such as the user 302 and the recipient 314. A presentation 312 to display the selected portion of underlying data 310 may be generated, and the presentation 312 may be displayed to the user 302 through a presentation viewer displayed on the mobile device 304. As illustrated, a file including only the presentation 312 may be transmitted to a client application 318 executed on another mobile device 316 associated with the recipient 314 for presentation to the recipient 314. Similarly, the presentation 312 may be displayed to the recipient 314 through a presentation viewer displayed on the other mobile device 316.

As previously discussed, both the user 302 and the recipient 314 may be enabled to modify the presentation 312 through the presentation viewer, where modifications may include an addition, a deletion, an edit, a comment, and other similar modifications to one or more elements of the presentation 312. In response to detecting a modification to the presentation 312 through the presentation viewer by the user 302 and/or the recipient 314, the corresponding underlying data 310 from the spreadsheet application 306 may be automatically updated to reflect the modification. Furthermore, a summary of the modifications may be provided to the user 302 through the spreadsheet application 306 or presentation viewer, and the recipient 314 through the presentation viewer.

In other examples, the user 302 may modify the selected portion of the underlying data 310 through the spreadsheet application 306. In response to detecting a modification to the selected portion of the underlying data 310 through the spreadsheet application 306, corresponding presentation elements displayed through the presentation viewers displayed on the mobile device 304 associated with the user 302 and the other mobile device 316 associated with the recipient 314 may be automatically updated to reflect the modification. A summary of the modifications may be provided to the user 302 and the recipient 314 through the respective presentation viewers.

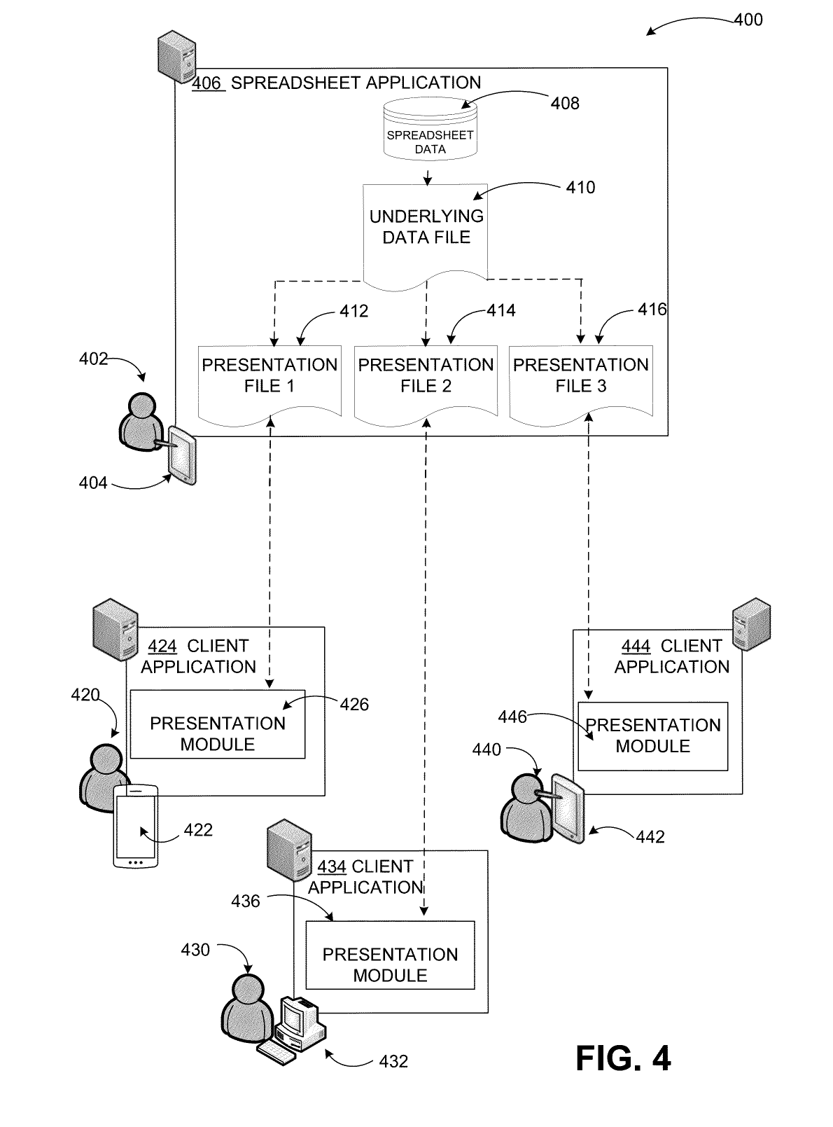

FIG. 4 illustrates an example conceptual diagram where content may be presented from within a spreadsheet application in a collaborative environment. As shown in a diagram 400, a spreadsheet application 406 may be executed locally on a client device 404, such as a tablet, associated with a user 402. The spreadsheet application 406 may include a data store 408 comprising underlying data associated with the spreadsheet application 406. The user 402 may be enabled to select a portion of the underlying data 410 to present to multiple recipients, such as the user 402 and the recipients 420, 430, 440. For example, the user 402 and the recipients 420, 430, 440 may be co-authors of a document. In some embodiments, only particular elements of the selected portion of the underlying data 410 may be relevant to each of the recipients 420, 430, 440. Accordingly, multiple presentations 412, 414, 416 to display the relevant elements of the selected portion of underlying data 410 associated with each of the recipients 420, 430, 440 may be generated. One or more of the presentations 412, 414, 416 may be displayed to the user 402 through a presentation viewer displayed on the client device 404. As illustrated, a file including only the presentations 412, 414, 416 may be transmitted to the respective client applications 424, 434, 444 executed on client devices 422, 432, 442 associated with the recipients 420, 430, 440. The presentations 412, 414, and 416 may be displayed to the recipients 420, 430, 440 through a presentation viewer displayed through presentation modules 426, 436, 436 of the client applications 424, 434, 444.

The user 402 and the recipients 420, 430, 440 may be enabled to modify the presentations 412, 414, 416 through the presentation viewer, where modifications may include an addition, a deletion, an edit, a comment, and other similar modifications.

In response to detecting a modification to any one of the presentations 412, 414, 416 through the presentation viewer by the user 402 and/or the respective recipients 420, 430, 440 the corresponding selected portion of the underlying data 410 from the spreadsheet application 406 may be automatically updated to reflect the modification. Furthermore, a summary of the modifications may be provided to the user 402 through the spreadsheet application 406 or presentation viewer, and the recipients 420, 430, 440 through the presentation viewer.

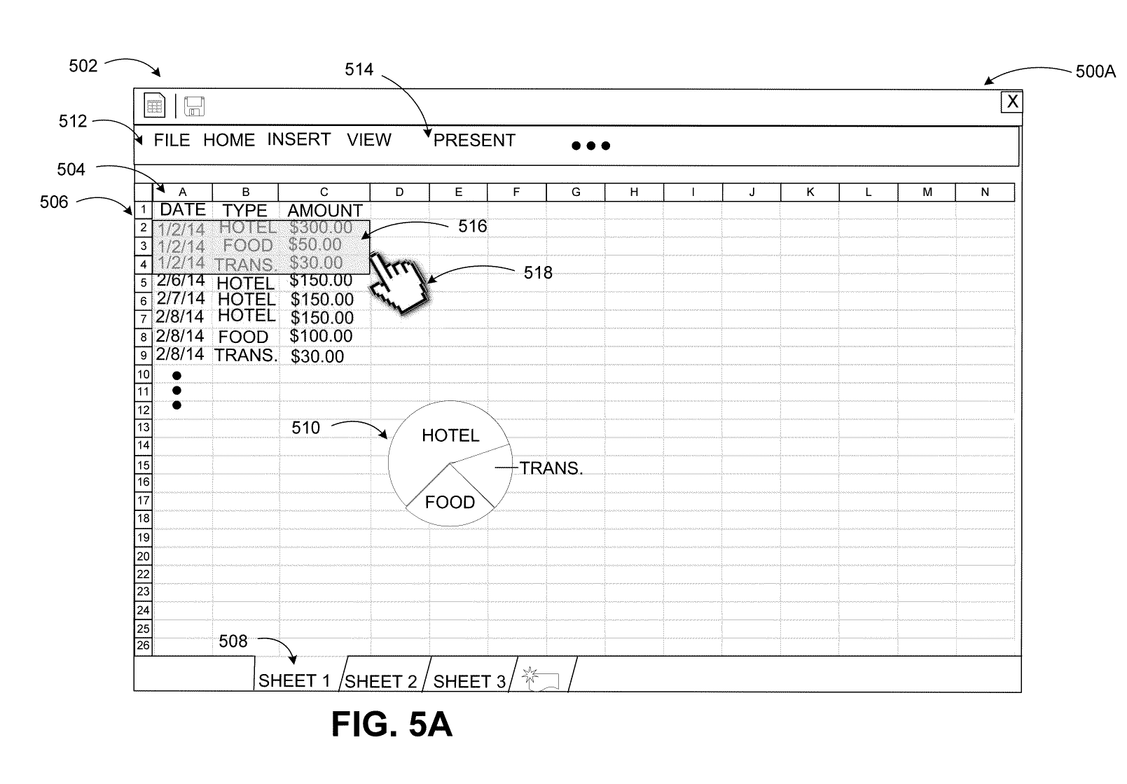

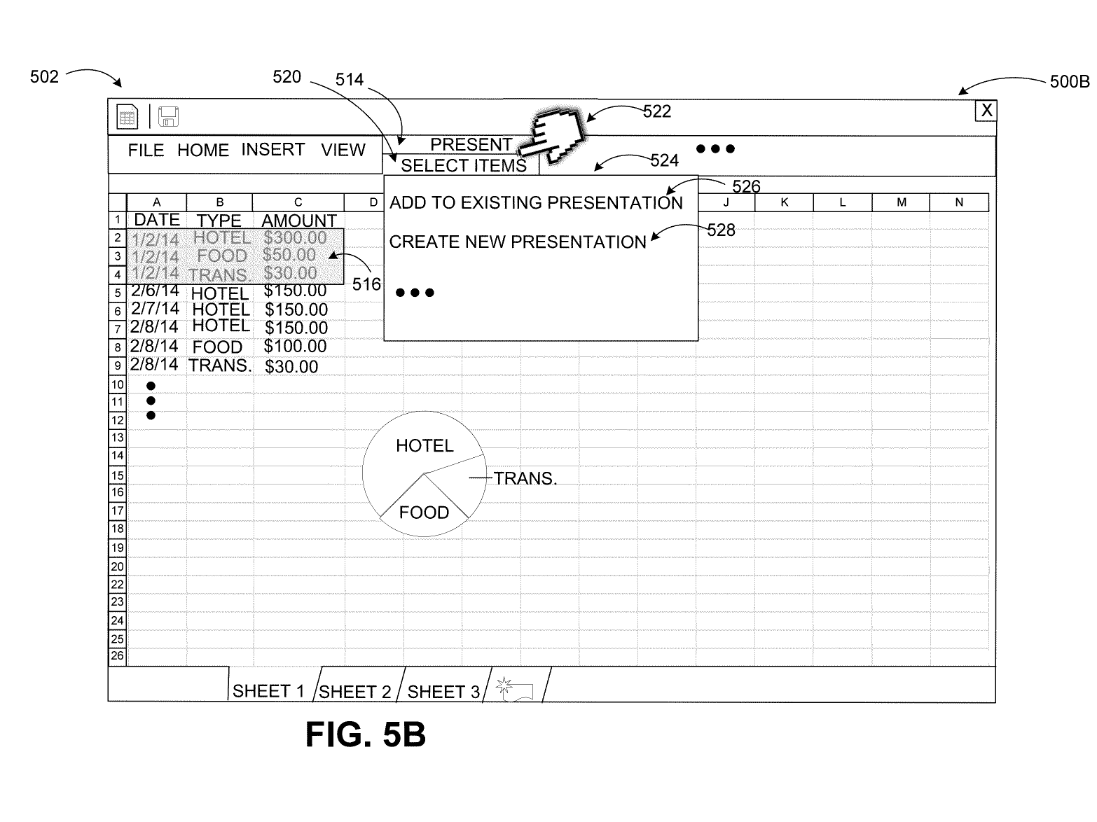

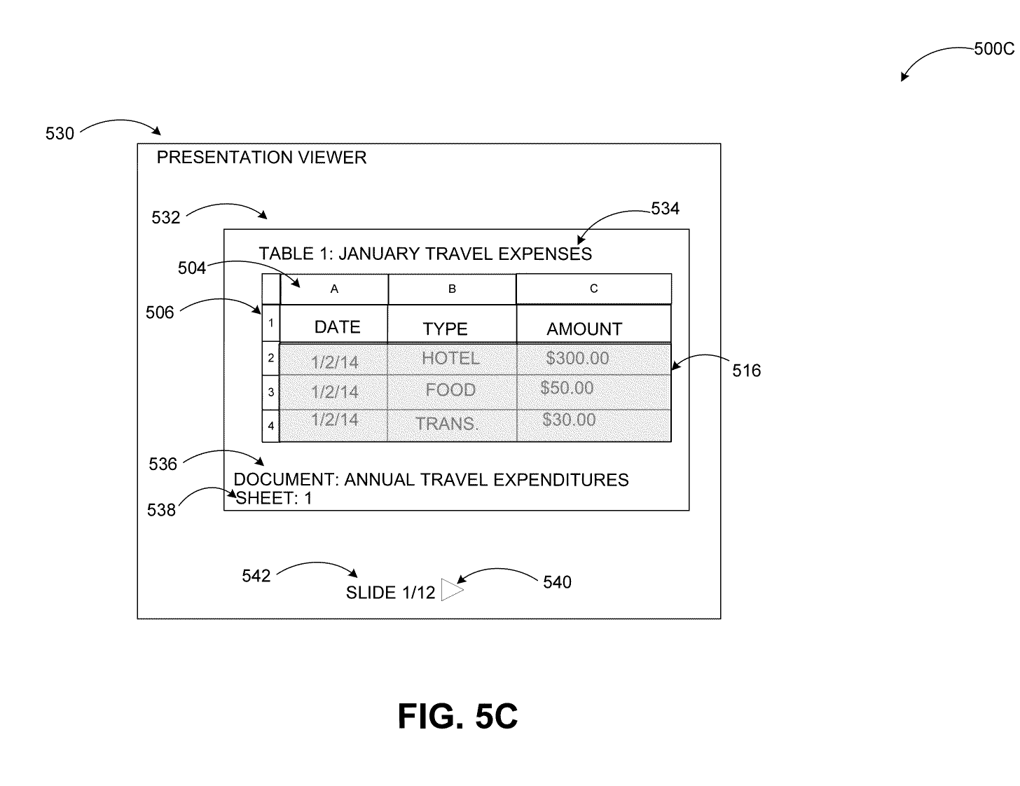

FIGS. 5A-5C illustrate an example user experience provided to enable a user to select content for presentation from within a spreadsheet application.

As shown in FIG. 5A, diagram 500A, a spreadsheet application 502 may enable a user to enter data into one or more columns 504 and rows 506 such that the user may organize, analyze, and store data in a tabular form within a document comprising one or more spreadsheets, such as spreadsheet 508. For example, the user may enter data associated with annual travel expenditures into the spreadsheet 508, where the columns 504 represent a date of the expenditure, a type of the expenditure, and an amount of the expenditure respectively, and the rows 506 may represent each date of expenditure and its corresponding type and amount of the expenditure. In some examples, the user may further be enabled to form charts and/or graphs 510 based on the data. As illustrated, a pie graph may be formed to visually represent an overall cost ratio of each type of expenditure, such as hotel, transportation, and food. A user experience of the spreadsheet application 502 may include a tool bar 512 providing the user with multiple control elements to enable interaction with the spreadsheet application 502. For example, the tool bar may include a “present” control element 514. In some embodiments, the user may be enabled to select a portion of the data 516 for presentation to one or more recipients. For example, the user may select the portion of the data 516 associated with travel expenses in the month of January. The portion of the data 516 may be selected through various user actions 518, including through touch input, gesture input, voice command, eye tracking, gyroscopic input, pen input, mouse input, and/or keyboard input, for example.

Once the portion of the data 516 has been selected, the user may actuate a “select items” control element 520 within the “present” control element 514, as shown in FIG. 5B, diagram 500B. The user may select and/or hover over the “select items” control element 520 through various user actions 522, including through touch input, gesture input, voice command, eye tracking, gyroscopic input, pen input, mouse input, and/or keyboard input, for example. In other examples, a user experience of the spreadsheet application 502 may automatically present an option to the user to present the selected portion of the underlying data 516 in response to the selection of the portion of the data 516. The selected portion of the data 516 may be received by a presentation module of the spreadsheet application 502. In some embodiments, in response to the user hovering over the “select items” control element 520 through one of the various user actions 522, a drop-down menu 524 may be presented to the user, as illustrated. The drop-down menu 524 may provide the user an option to add the selected portion of the data 516 to an existing presentation 526 or to create a new presentation 528 for the selected portion of the data 516, among other options. The presentation module may then be configured generate a new presentation or modify an existing presentation to display the selected portion of the data 516. In some embodiments, the presentation may be generated and/or modified as one or more slides.

As shown in FIG. 5C, diagram 500C, display of presentation 532 to the recipients may be enabled through a presentation viewer 530. The presentation viewer 530 may employ a textual scheme, a graphical scheme, an audio scheme, an animation scheme, a coloring scheme, a highlighting scheme, and/or a shading scheme to enhance the display of the presentation 532. The presentation 532 may be a slide that includes the selected portion of the data 516 in a tabular form, including the associated columns 504 and rows 506 of the spreadsheet application 502 and a title 534 representative of the selected portion of the data 516, such as “Table 1: January Travel Expenses.” The presentation 532 may also include contextual data associated with the document and the spreadsheet 508 within the document from which the selected portion of the data 516 was retrieved, such as a title 536 of the document and an indicator 538 of the spreadsheet 508. The indicator 538 may include a title or a number of the spreadsheet 508, for example. The presentation viewer 530 may also include a control element 540 that enables the recipients to navigate through a presentation, in response to a determination that the presentation includes two or more slides. The control element 540 may have an associated textual element 542 to indicate which slide number the user is currently viewing out of a total number of slides in the presentation. In an example scenario, if the user that selected the portion of the data 516 chose to add the data to an existing presentation, as described previously in FIG. 5B, the slide generated for the selected portion of the data 516 may be added to one or more pre-existing slides. For example, a slide may have been generated for each month of the year in order to distinctly present monthly travel expenditures for the year in the presentation. Accordingly, the selected portion of the data 516 associated with January travel expenditures may be presented as a first slide out of twelve slides, as illustrated, where the eleven other slides associated with the other eleven months had been previously been generated for presentation to the recipients.

In some embodiments, the recipients may be enabled to modify the presentation 532 through the presentation viewer 530. In response to detecting recipient modification to the presentation 532, the presentation module may be configured to automatically update the corresponding portion of data within the spreadsheet application 502. Alternatively, in response to detecting user modification to the portion of the data 516 within the spreadsheet application 502 following presentation, the presentation module may be configured to automatically update the presentation 532 within the presentation viewer 530.

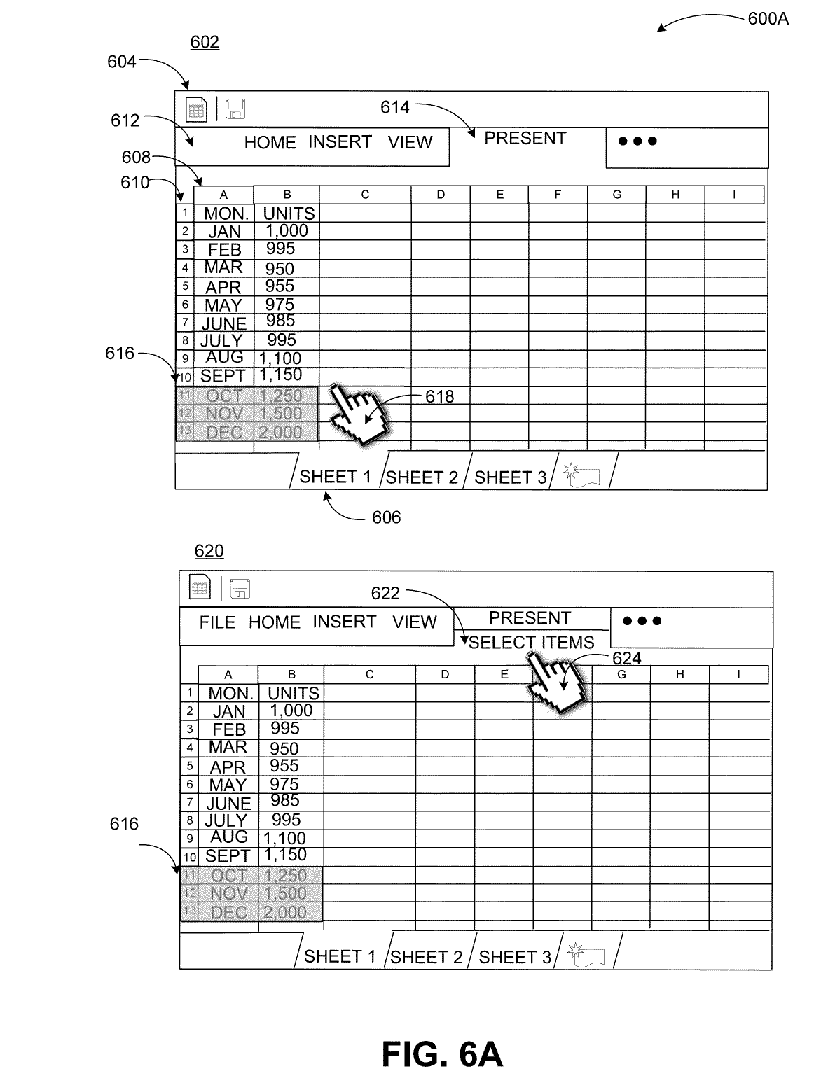

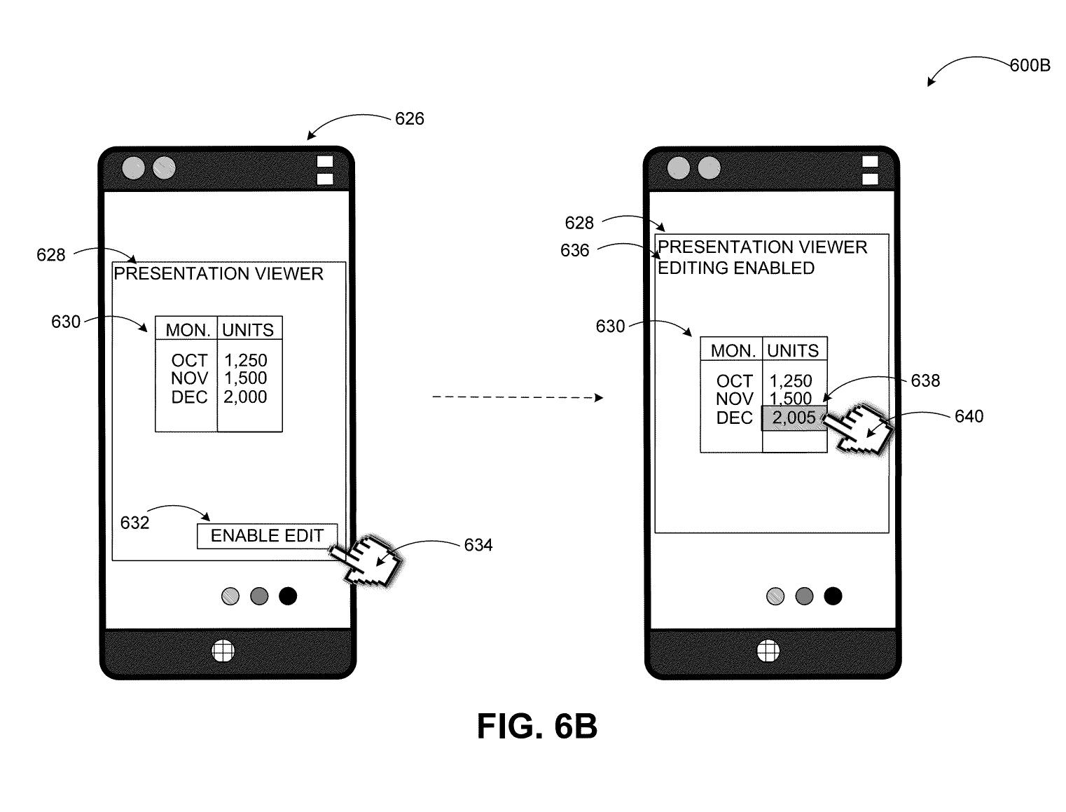

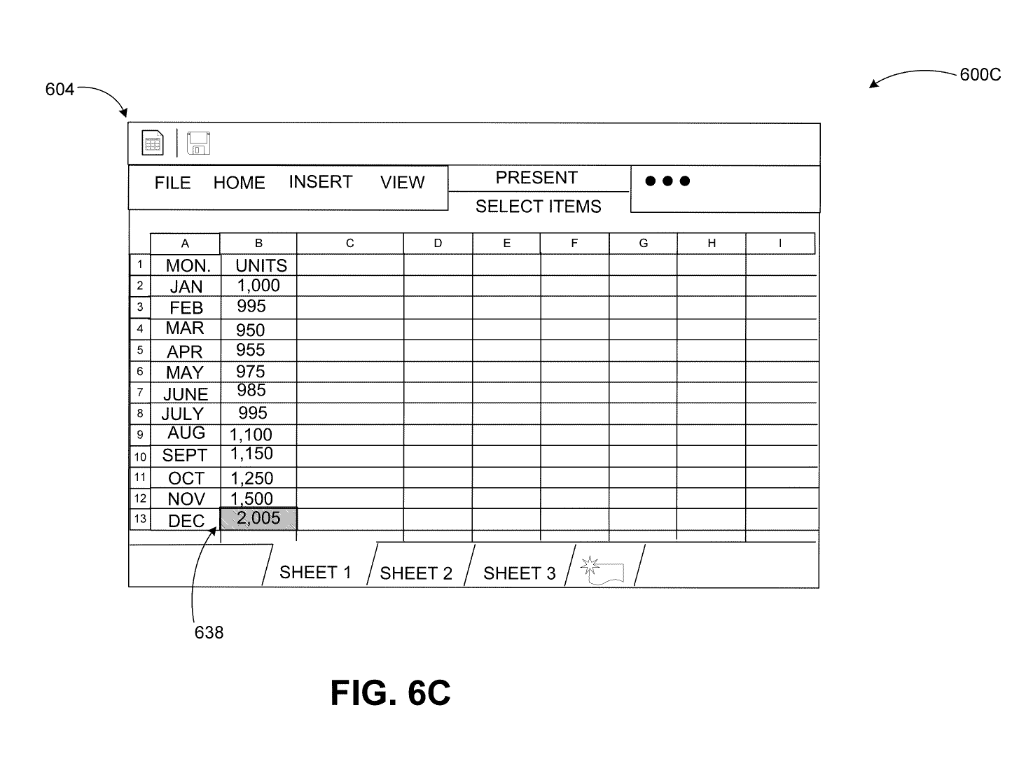

FIGS. 6A-6C illustrate an example user experience provided to enable a user to dynamically present content from within a spreadsheet application to recipients, where the recipients are enabled to modify the presented content.

As shown in FIG. 6A, diagram 600A, configuration 602, a spreadsheet application 604 may enable a user to enter data into one or more columns 608 and rows 610 such that the user may organize, analyze, and store data in a tabular form within a spreadsheet 606. For example, the user may enter data associated with a number of units sold per month over the past year into the spreadsheet application 604, where the columns 608 represent months and units, respectively, and the rows 610 represent each month and its corresponding number of units sold. A user experience of the spreadsheet application 604 may include a tool bar 612 providing the user with multiple control elements to enable interaction with the spreadsheet application 604. For example, the tool bar may include a “present” control element 614. In some embodiments, the user may be enabled to select a portion of the data 616 for presentation to one or more recipients. The portion of the data 616 selected may include the number of units sold per month over a last quarter of the year (and thus, the number of units sold per month from October to December). The portion of the data 616 may be selected through various user actions 618, including through touch input, gesture input, voice command, eye tracking, gyroscopic input, pen input, mouse input, and/or keyboard input, for example.

Once the portion of the data 616 has been selected, the user may actuate a “select items” control element 622 within the “present” control element 614, as shown in configuration. The “select items” control element 622 may be actuated through various user actions 624, including through touch input, gesture input, voice command, eye tracking, gyroscopic input, pen input, mouse input, and/or keyboard input, for example. The selected portion of the data 616 may be received by a presentation module of the spreadsheet application 604. The presentation module may be configured generate a presentation to display the selected portion of the data 616.

As shown in FIG. 6B, diagram 600B, display of the presentation 630 (that is, the selected portion of the data 616) to the recipient may be enabled through a presentation viewer 628 on a mobile device 626. Accordingly, the presentation 630 may be configured for display on the mobile device 626 based on one or more capabilities of the mobile device 626. In some embodiments, the recipient may be enabled to modify the presentation 630 through the presentation viewer 628. In some examples, the presentation viewer 628 may include a “enable edit” control element 632 that when selected through a recipient action 634, may enable the recipient to modify the presentation 630. For example, once the “enable edit” control element 632 has been selected, the presentation viewer 628 may indicate to the recipient that editing is enabled 636 through a textual and/or graphical scheme. The recipient may then add, delete, edit, and/or comment on the presentation through the presentation viewer 628. For example, the recipient may select a cell 638 from the presentation to edit via a recipient action 640, where the edit may be to change the number of units sold in December from 2,000 to 2,005, for example.

In response to detecting recipient modification to the presentation 630 through the presentation viewer 628, the presentation module may be configured to automatically update the corresponding portion of data (that is, cell 638) within the spreadsheet application 604, as shown in FIG. 6C, diagram 600C.

The examples in FIGS. 1 through 6C have been described using specific network environments, systems, applications, and user experiences for presentation of content from within a spreadsheet application. Embodiments for presentation of content from within a spreadsheet application are not limited to the specific network environments, systems, applications, and user experiences according to these examples.

Presentation of content from within a spreadsheet application, as described in the embodiments herein, may enable a single application with spreadsheet and presentation capabilities to be executed in order to present content, which may advantageously reduce the bandwidth previously required when having to execute two applications (that is, a spreadsheet application and a separate presentation application). The reduced bandwidth may enable faster communication among users and recipients, which may increase user and recipient performance and/or efficiency. Additionally, dynamic updates of modified data between the spreadsheet application and presentation viewer may improve usability. For example, the dynamic updates may save the user time and frustration by not having to copy and paste data continuously between applications, which may further increase user performance and/or efficiency. Furthermore, by enabling the user to select only relevant portions for presentation, the presentation may be friendly to view on devices with smaller display screens, improving usability. For example, a large spreadsheet data file may be arduous to view through a small display screen of a mobile device, especially if only a few portions of the data are relevant. Accordingly, by selecting only a relevant portion of the spreadsheet data to present, viewing the data becomes simple through the mobile device.

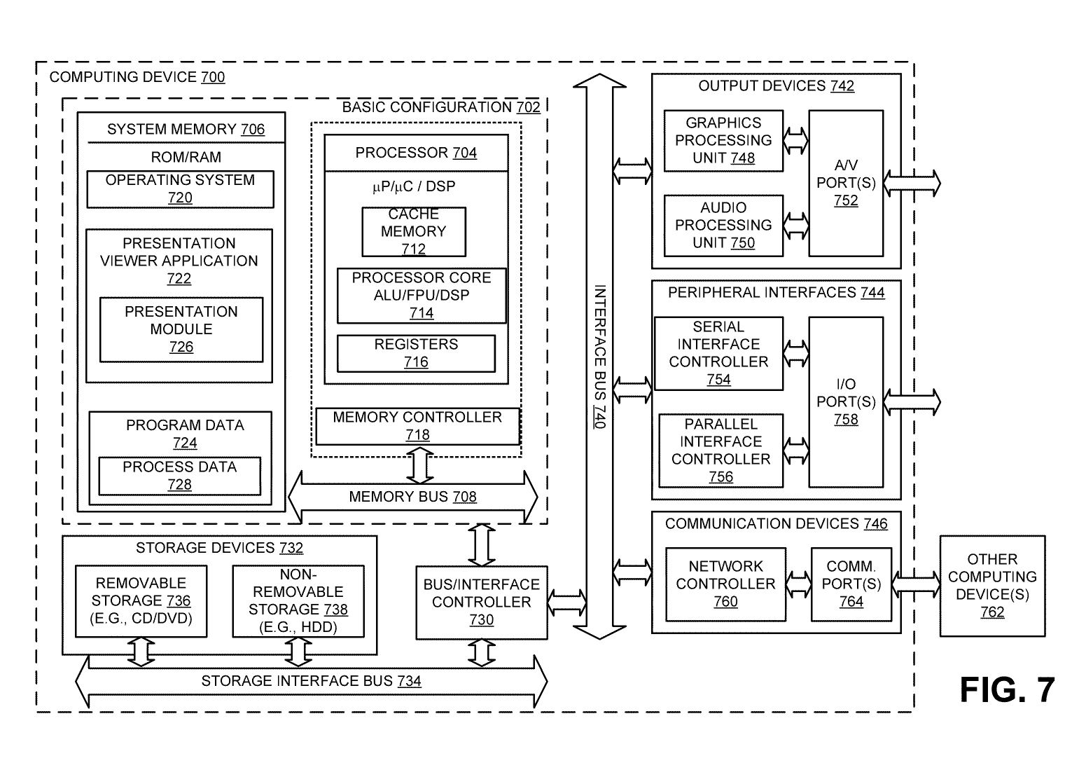

FIG. 7 and the associated discussion are intended to provide a brief, general description of a general purpose computing device, which may be used to present content from within a spreadsheet application.

For example, computing device 700 may be used as a server, desktop computer, portable computer, smart phone, special purpose computer, or similar device. In an example basic configuration 702, the computing device 700 may include one or more processors 704 and a system memory 706. A memory bus 708 may be used for communicating between the processor 704 and the system memory 706. The basic configuration 702 is illustrated in FIG. 7 by those components within the inner dashed line.

Depending on the desired configuration, the processor 704 may be of any type, including but not limited to a microprocessor (μP), a microcontroller (μC), a digital signal processor (DSP), or any combination thereof The processor 704 may include one more levels of caching, such as a level cache memory 712, one or more processor cores 714, and registers 716. The example processor cores 714 may (each) include an arithmetic logic unit (ALU), a floating point unit (FPU), a digital signal processing core (DSP Core), or any combination thereof. An example memory controller 718 may also be used with the processor 704, or in some implementations the memory controller 718 may be an internal part of the processor 704.

Depending on the desired configuration, the system memory 706 may be of any type including but not limited to volatile memory (such as RAM), non-volatile memory (such as ROM, flash memory, etc.) or any combination thereof The system memory 706 may include an operating system 720, a presentation viewer application 722, and program data 724. The presentation viewer application 722 may include a presentation module 726, which may be an integrated module of the presentation viewer application 722 or a separate application. The presentation module 726 may be configured to receive a selected portion of the underlying data of the spreadsheet application, generate a presentation to display the selected portion of the underlying data, and enable display of the presentation to one or more recipients through a presentation viewer. The program data 724 may include, among other data, process data 728 related to modification of the data within one or both of the presentation viewer application 722 and the presentation viewer, as described herein.

The computing device 700 may have additional features or functionality, and additional interfaces to facilitate communications between the basic configuration 702 and any desired devices and interfaces. For example, a bus/interface controller 730 may be used to facilitate communications between the basic configuration 702 and one or more data storage devices 732 via a storage interface bus 734. The data storage devices 732 may be one or more removable storage devices 736, one or more non-removable storage devices 738, or a combination thereof. Examples of the removable storage and the non-removable storage devices include magnetic disk devices such as flexible disk drives and hard-disk drives (HDDs), optical disk drives such as compact disk (CD) drives or digital versatile disk (DVD) drives, solid state drives (SSD), and tape drives to name a few. Example computer storage media may include volatile and nonvolatile, removable and non-removable media implemented in any method or technology for storage of information, such as computer readable instructions, data structures, program modules, or other data.

The system memory 706, the removable storage devices 736 and the non-removable storage devices 738 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 700. Any such computer storage media may be part of the computing device 700.

The computing device 700 may also include an interface bus 740 for facilitating communication from various interface devices (for example, one or more output devices 742, one or more peripheral interfaces 744, and one or more communication devices 746) to the basic configuration 702 via the bus/interface controller 730. Some of the example output devices 742 include a graphics processing unit 748 and an audio processing unit 750, which may be configured to communicate to various external devices such as a display or speakers via one or more AN ports 752. One or more example peripheral interfaces 744 may include a serial interface controller 754 or a parallel interface controller 757, which may be configured to communicate with external devices such as input devices (for example, keyboard, mouse, pen, voice input device, touch input device, etc.) or other peripheral devices (for example, printer, scanner, etc.) via one or more I/O ports 758. An example communication device 746 includes a network controller 760, which may be arranged to facilitate communications with one or more other computing devices 762 over a network communication link via one or more communication ports 764. The one or more other computing devices 762 may include servers, computing devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 700 may be implemented as a part of a general purpose or specialized server, mainframe, or similar computer that includes any of the above functions. The computing device 700 may also be implemented as a personal computer including both laptop computer and non-laptop computer configurations.

Example embodiments may also include methods to present content from within a spreadsheet application. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

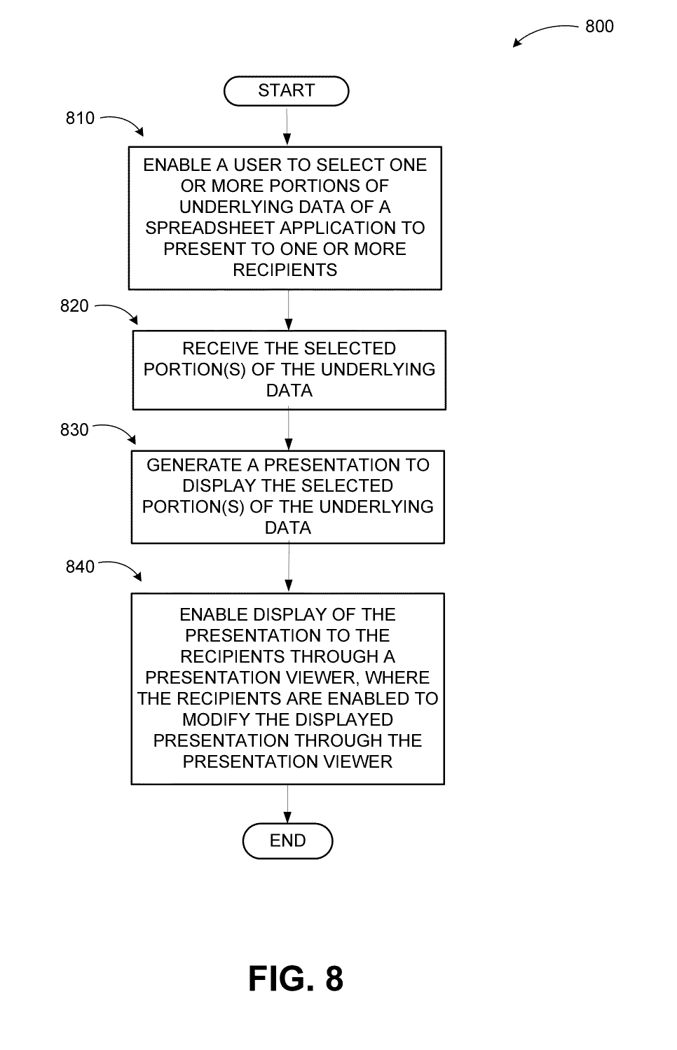

FIG. 8 illustrates a logic flow diagram for process 800 of a method to present content from within a spreadsheet application, according to embodiments. Process 800 may be implemented on a server or other system.

Process 800 begins with operation 810, where a user may be enabled to select one or more portions of underlying data of a spreadsheet application to present to one or more recipients. User access to the spreadsheet application may be provided through a client application, for example, where a control element displayed on a user experience associated with the spreadsheet application may enable the user to select the portions of underlying data. In other examples, the spreadsheet application may automatically provide the user an option to present the selected portion of the underlying data through the user experience upon selection of the portion of the underlying data by the user. The selected portions may be the same or different for each of the recipients, where the recipients may include the user that has selected the selected portions of the underlying data, and one or more other users intended to receive the presentation.

At operation 820, the selected portions of the underlying data may be received at a presentation module of the client application. At operation 830, a presentation may be generated to display the selected portions of the underlying data, where the presentation may be generated as one or more slides, for example.

At operation 840, the display of the presentation to the recipients may be enabled through a presentation viewer. In some examples, the display of the presentation may be enabled through a presentation viewer on a mobile device, where the presentation may be configured for the presentation viewer based on one or more capabilities of the mobile device. The recipients may be enabled to modify the displayed presentation through the presentation viewer. In response to detecting a modification through the presentation viewer, corresponding underlying data of the spreadsheet application may be automatically updated. Additionally or alternatively, in response to detecting a modification through the spreadsheet application, corresponding presentation elements displayed through the presentation view may be automatically updated.

The operations included in process 800 are for illustration purposes. Presentation of content from within a spreadsheet application may be implemented by similar processes with fewer or additional steps, as well as in different order of operations using the principles described herein.

A means for presenting content from within a spreadsheet application may include a means for receiving a selected portion of underlying data of the spreadsheet application, a means for generating a presentation to display the selected portion of underlying data, and a means for enabling display of the presentation to one or more recipients through a presentation viewer, where the recipients may be enabled to modify the displayed presentation through the presentation viewer.

According to some examples, systems configured to present content from within a spreadsheet application are described. An example system may include a first server configured to manage underlying data of a spreadsheet application, and a second server configured to provide access to the spreadsheet application to a plurality of users. A presentation module of the spreadsheet application may be configured to receive a selected portion of the underlying data from the first server, generate a presentation to display the selected portion of the underlying data, and enable display of the presentation to one or more recipients through a presentation viewer, wherein the recipients may be enabled to modify the displayed presentation through the presentation viewer.

In other examples, the selected portion of the underlying data may include cells, row, columns, tables, charts, graphs, and images. The spreadsheet application may be configured to employ at least one of a textual scheme, a graphical scheme, an audio scheme, an animation scheme, a coloring scheme, a highlighting scheme, and a shading scheme to enhance the display of the presentation through the presentation viewer. The spreadsheet application may be a web application or is hosted by a third party service. The spreadsheet application may be further configured to enable a user to select the selected portion of the underlying data through a control element displayed on a user experience associated with the spreadsheet application.

In further examples, the spreadsheet application is further configured to automatically provide the user an option to present the selected portion of the underlying data through the user experience upon selection of the portion of the underlying data by the user. The one or more recipients may include a user that has selected the portion of the underlying data and one or more other users intended to receive the presentation through the presentation viewer. The modifications may include adding, deleting, editing, and commenting on one or more elements of the presentation. The spreadsheet application may be further configured to assign the recipients permissions associated with the modifications.

According to some embodiments, methods to present content from within a spreadsheet application are provided. An example method may include receiving a selected portion of underlying data of the spreadsheet application, generating a presentation to display the selected portion of the underlying data, and enabling display of the presentation to one or more recipients through a presentation viewer, where the recipients may be enabled to modify the displayed presentation through the presentation viewer.

In other embodiments, corresponding underlying data within the spreadsheet application may be automatically updated to reflect the modification in response to detecting a modification to the displayed presentation through the presentation viewer. A summary of the modification may be presented through one or both of the spreadsheet application and presentation viewer. The displayed presentation may be automatically updated through the presentation viewer to reflect the modification in response to detecting a modification to the selected portion of the underlying data within the spreadsheet application.

In further embodiments, generating the presentation to display the selected portion of the underlying data may further include generating the presentation as one or more slides. Multiple selected portions of underlying data of the spreadsheet application may be received for presentation to the recipients simultaneously, wherein each of the multiple selected portions of underlying data for presentation is associated with one of the recipients.

According to some examples, computing devices configured to present content from within a spreadsheet application are described. An example computing device may include a memory configured to store one or more instructions, and a processor coupled to the memory. The processor may be configured to execute a presentation viewer application in conjunction with the instructions, where the presentation viewer application may be configured to receive a presentation based on a selected portion of underlying data associated with the spreadsheet application, enable display of the presentation to a recipient through a presentation viewer application user experience, where the recipient may be enabled to modify the displayed presentation through the user experience, and in response to detecting a modification to the displayed presentation through the user experience transmit an update to the corresponding underlying data to another computing device that executes the spreadsheet application. The example computing device may also include a display device coupled to the processor, where the display device may be configured to display the presentation viewer application user experience.

In other examples, the processor may be configured to receive the presentation and the selected portion of the underlying data as a single file from the other computing device. The processor may be configured to receive the presentation and the selected portion of the underlying data as separate files from the other computing device. The computing device may be a mobile device associated with the recipient. The presentation viewer application may be configured to adjust the presentation for display through the mobile device based on one or more capabilities of the mobile device.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A system configured to present content from within a spreadsheet application, the system comprising:
a first server configured to manage underlying data of a spreadsheet application; and
a second server configured to provide access to the spreadsheet application to a plurality of users, wherein a presentation module of the spreadsheet application is configured to:
receive a selected portion of the underlying data from the first server;
generate a presentation to display the selected portion of the underlying data; and
enable display of the presentation to one or more recipients through a presentation viewer, wherein the one or more recipients are enabled to modify the displayed presentation through the presentation viewer.

2. The system of claim 1, wherein the selected portion of the underlying data includes one or more of cells, row, columns, tables, charts, graphs, and images.

3. The system of claim 1, wherein the spreadsheet application is configured to employ at least one of a textual scheme, a graphical scheme, an audio scheme, an animation scheme, a coloring scheme, a highlighting scheme, and a shading scheme to enhance the display of the presentation through the presentation viewer.

4. The system of claim 1, wherein the spreadsheet application is one of a web application or hosted by a third party service.

5. The system of claim 1, wherein the spreadsheet application is further configured to enable a user to select the selected portion of the underlying data through a control element displayed on a user experience associated with the spreadsheet application.

6. The system of claim 5, wherein the spreadsheet application is further configured to automatically provide the user an option to present the selected portion of the underlying data through the user experience upon selection of the portion of the underlying data by the user.

7. The system of claim 1, wherein the one or more recipients include a user that has selected the portion of the underlying data and one or more other users intended to receive the presentation through the presentation viewer.

8. The system of claim 1, wherein the modifications include one or more of adding, deleting, editing, and commenting on one or more elements of the presentation.

9. The system of claim 8, wherein the spreadsheet application is further configured to assign the one or more recipients permissions associated with the modifications.

10. A method to present content from within a spreadsheet application, the method comprising:
receiving a selected portion of underlying data of the spreadsheet application;
generating a presentation to display the selected portion of the underlying data; and
enabling display of the presentation to one or more recipients through a presentation viewer, wherein the one or more recipients are enabled to modify the displayed presentation through the presentation viewer.

11. The method of claim 10, further comprising:
in response to detecting a modification to the displayed presentation through the presentation viewer, automatically updating corresponding underlying data within the spreadsheet application to reflect the modification.

12. The method of claim 11, further comprising:
presenting a summary of the modification through one or both of the spreadsheet application and presentation viewer.

13. The method of claim 10, further comprising:
in response to detecting a modification to the selected portion of the underlying data within the spreadsheet application, automatically updating the displayed presentation through the presentation viewer to reflect the modification.

14. The method of claim 10, wherein generating the presentation to display the selected portion of the underlying data further comprises:
generating the presentation as one or more slides.

15. The method of claim 10, further comprising:
receiving multiple selected portions of underlying data of the spreadsheet application for presentation to the one or more recipients simultaneously, wherein each of the multiple selected portions of underlying data for presentation is associated with one of the one or more recipients.

16. A computing device configured to present content from within a spreadsheet application, the computing device comprising:
a memory configured to store one or more instructions;
a processor coupled to the memory, the processor is configured to execute a presentation viewer application in conjunction with the one or more instructions, wherein the presentation viewer application is configured to:
receive a presentation based on a selected portion of underlying data associated with the spreadsheet application;
enable display of the presentation to a recipient through a presentation viewer application user experience, wherein the recipient is enabled to modify the displayed presentation through the user experience; and
in response to detecting a modification to the displayed presentation through the user experience, transmit an update to corresponding underlying data to another computing device that executes the spreadsheet application; and
a display device coupled to the processor, wherein the display device is configured to display the presentation viewer application user experience.

17. The computing device of claim 16, wherein the processor is configured to receive the presentation and the selected portion of the underlying data as a single file from the other computing device.

18. The computing device of claim 16, wherein the processor is configured to receive the presentation and the selected portion of the underlying data as separate files from the other computing device.

19. The computing device of claim 16, wherein the computing device is a mobile device associated with the recipient.

20. The computing device of claim 19, wherein the presentation viewer application is configured to adjust the presentation for display through the mobile device based on one or more capabilities of the mobile device.
